(19) United States
(12) Patent Application Publication
(10) Pub. No.: US 2013/0250311 A1
(43) Pub. Date: Sep. 26, 2013

(54) DETECTING DEVICE AND METHOD FOR DETECTING A TRANSPARENT GRATING STRUCTURE

(71) Applicant: HITI DIGITAL, INC., New Taipei City (TW)

(72) Inventors: Tsung-Yueh Chen, Taipei City (TW); Chih-Chieh Lin, Taipei City (TW)

(73) Assignee: HITI DIGITAL, INC., New Taipei City (TW)

(21) Appl. No.: 13/689,667

(22) Filed: Nov. 29, 2012

(30) Foreign Application Priority Data
Mar. 22, 2012 (TW) 101109842

(51) Int. Cl. G01B 11/14

(52) U.S. Cl. CPC G01B 11/14
USPC 356/615

(57) ABSTRACT

A detecting device includes an actuating unit for driving a transparent grating structure, a light source for emitting light to the transparent grating structure driven by the actuating unit, a light sensor for sensing the light emitted from the light source as the transparent grating structure is moved to different positions relative to the light source so as to generate a corresponding optical intensity signal, a transforming circuit coupled to the light sensor for transforming the optical intensity signal into a transforming signal, and a processing unit coupled to the transforming circuit for determining a position of the transparent grating structure according to the transforming signal transmitted from the transforming circuit.

### BACKGROUND OF THE INVENTION

1. Field of the Invention

The present invention relates to a detecting device and a method for detecting a transparent grating structure, and more specifically, to a detecting device and a method for detecting a transparent grating structure by an optical intensity signal.

2. Description of the Prior Art

In conventional procedure for producing stereoscopic images, because a grating plate is made of transparent material, it is hard to detect and locate the grating plate. Therefore a common method is to print the stereoscopic image on an opaque substrate, such as photographic paper or cards, and so on. And then the transparent grating plate can be glued on the substrate for detection and position, so as to produce a stereoscopic visual effect. The interlaced pattern on the grating plate is designed according to parameters of the grating plate, such as a width and a density of gratings on the grating plate. Grates on the grating plate need to align with the corresponding image, so as to present the precise stereoscopic image. However, it results in manufacturing difficulty of the stereoscopic image and increase of manufacturing cost.

### SUMMARY OF THE INVENTION

The present invention is to provide a detecting device and a method for detecting a transparent grating structure to solve above problems.

According to the disclosure, a detecting device includes an actuating unit, a light source, a light sensor, a transforming circuit and a processing unit. The actuating unit is for driving a transparent grating structure. The light source is for emitting light to the transparent grating structure driven by the actuating unit. The light sensor is for sensing the light emitted from the light source as the transparent grating structure is moved to different positions relative to the light source so as to generate a corresponding optical intensity signal. The transforming circuit is coupled to the light sensor for transforming the optical intensity signal into a transforming signal. The processing unit is coupled to the transforming circuit for determining a position of the transparent grating structure according to the transforming signal transmitted from the transforming circuit.

According to the disclosure, the light source is a light emitting diode, and the light sensor is an optical interrupter sensor for sensing the light emitted from the light source and passing through the transparent grating structure so as to generate the corresponding optical intensity signal.

According to the disclosure, the light source is disposed at a planar side of the transparent grating structure, and the light sensor is disposed at a cylindrical side of the transparent grating structure.

According to the disclosure, the light sensor generates the maximum optical intensity signal when a top of the transparent grating structure is moved to a position between the light source and the light sensor.

According to the disclosure, the light sensor generates the minimum optical intensity signal when an edge of the transparent grating structure is moved to a position between the light source and the light sensor.

According to the disclosure, the light source is a light emitting diode, and the light sensor is an optical reflective sensor for sensing the light emitted from the light source and reflected by the transparent grating structure so as to generate the corresponding optical intensity signal.

According to the disclosure, the light source and the light sensor are disposed at a cylindrical side of the transparent grating structure.

According to the disclosure, the light sensor generates the minimum optical intensity signal when a top of the transparent grating structure is moved to a position relative to the light source.

According to the disclosure, the transforming circuit is for amplifying level changes of the optical intensity signal so as to generate the transforming signal.

According to the disclosure, a direction of movement of the transparent grating structure driven by the actuating unit is substantially vertical to a direction of the light emitted from the light source.

According to the disclosure, a method for detecting a transparent grating structure including following steps: driving the transparent grating structure, a light source emitting light to the transparent grating structure, a light sensor sensing the light emitted from the light source as the transparent grating structure is moved to different positions relative to the light source so as to generate a corresponding optical intensity signal, transforming the optical intensity signal generated by the light sensor into a transforming signal, and determining a position of the transparent grating structure according to the transforming signal.

The detecting device and the detecting method of the present invention can utilize the light sensor and the transforming circuit to detect and locate the transparent grating structure directly. Therefore, there is no need to print the stereoscopic image on an opaque substrate, such as photographic paper or cards and so on, and then to stick the transparent grating plate on the substrate. That is, the step of configuring the substrate and sticking the transparent grating plate on the substrate can be omitted. For example, the stereoscopic image can be directly printed on the planar side of the transparent grating plate, so as to reduce manufacturing difficulty and cost greatly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a detecting device according to a preferred embodiment of the present invention.

FIG. 2 is a flowchart of detecting a transparent grating structure according to the preferred embodiment of the present invention.

FIG. 3 to FIG. 6 are respectively diagrams of a light source, a light sensor and the transparent grating structure in different positions according to the preferred embodiment of the present invention.

FIG. 7 is a diagram of transforming an optical intensity signal into a transforming signal according to the preferred embodiment of the present invention.

FIG. 8 is a diagram of the detecting device according to another embodiment of the present invention.

### DETAILED DESCRIPTION

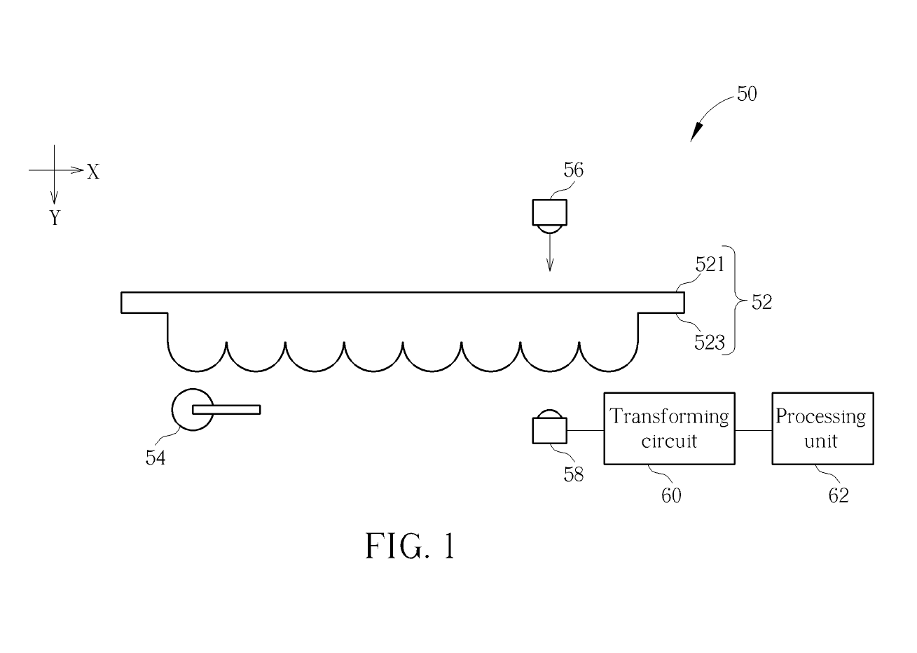

Please refer to FIG. 1. FIG. 1 is a diagram of a detecting device 50 according to a preferred embodiment of the present invention. The detecting device 50 is for detecting position of gratings of a transparent grating structure 52, so as to be a basis of following location and printing. The transparent grating structure 52 can be made of transparent material, such as acrylic, PVC, PET and so on, and the transparent grating structure 52 includes a planar side 521 and a cylindrical side 523. A stereoscopic image, such as an interlaced image, can be directly printed on the planar side 521. A plurality of cylindrical structures is formed on the cylindrical side 523 with equal spacing, and a plurality of convex lens is formed by convexes of the cylindrical structures so as to present different stereoscopic visual effects in different view angles. The detecting device 50 includes an actuating unit 54 for driving the transparent grating structure 52 to move in the X direction. The detecting device 50 further includes a light source 56 for emitting light in the Y direction to the transparent grating structure 52 driven by the actuating unit 54. A direction (X direction) of the transparent grating structure 52 driven by the actuating unit 54 can be substantially vertical to a direction (Y direction) of the light emitted from the light source 56. The light source 56 can be a light emitting diode.

The detecting device 50 further includes alight sensor 58 for sensing the light emitted from the light source 56 as the transparent grating structure 52 is moved to different positions relative to the light source 56, so as to generate a corresponding optical intensity signal. The light sensor 58 can be an optical interrupter sensor or an optical reflective sensor. The detecting device 50 further includes a transforming circuit 60 coupled to the light sensor 58. The transforming circuit 60 is for transforming the optical intensity signal generated by the light sensor 58 into a transforming signal, such as transforming an analog signal into a recognizable digital signal. For example, level changes of the optical intensity signal generated by the light sensor 58 are weak, so the transforming circuit 60 can be utilized for amplifying the level changes of the optical intensity signal so as to generate the transforming signal. In addition, the detecting device 50 further includes a processing unit 62 coupled to the transforming circuit 60 for determining every position of the grating of the transparent grating structure 52 according to the transforming signal transmitted from the transforming circuit 60.

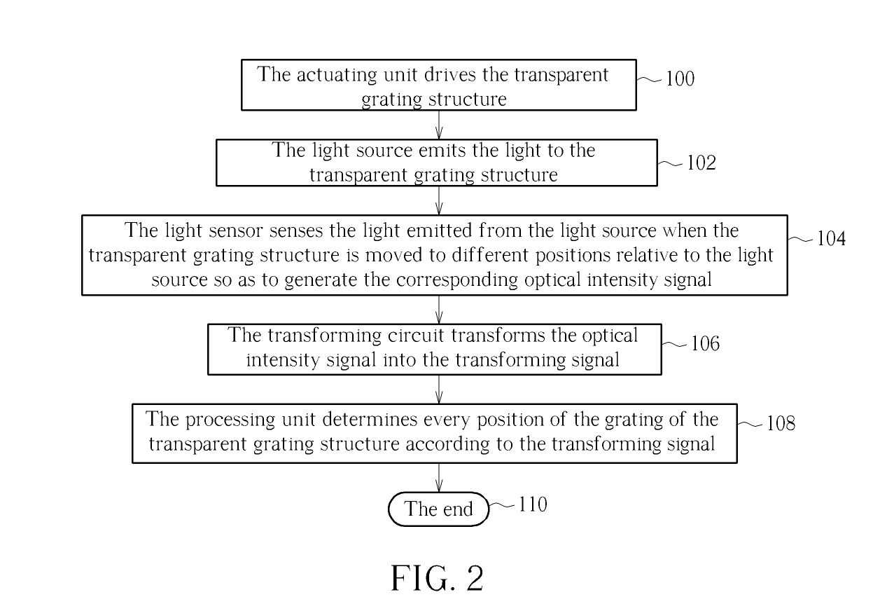

Please refer to FIG. 2. FIG. 2 is a flowchart of detecting the transparent grating structure 52 according to the preferred embodiment of the present invention. The method includes following steps:

Step 100: The actuating unit 54 drives the transparent grating structure 52 to move in the X direction.

Step 102: The light source 56 emits the light in the Y direction to the transparent grating structure 52 driven by the actuating unit 54.

Step 104: The light sensor 58 senses the light emitted from the light source 56 so as to generate the corresponding optical intensity signal.

Step 106: The transforming circuit 60 transforms the optical intensity signal generated by the light sensor 58 into the transforming signal.

Step 108: The processing unit 62 determines every position of the grating of the transparent grating structure 52 according to the transforming signal transmitted from the transforming circuit 60.

Step 110: The end.

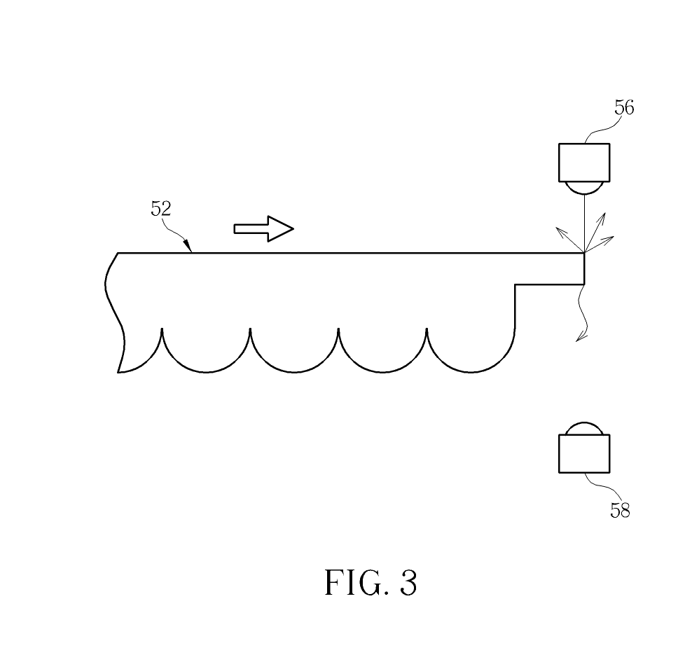

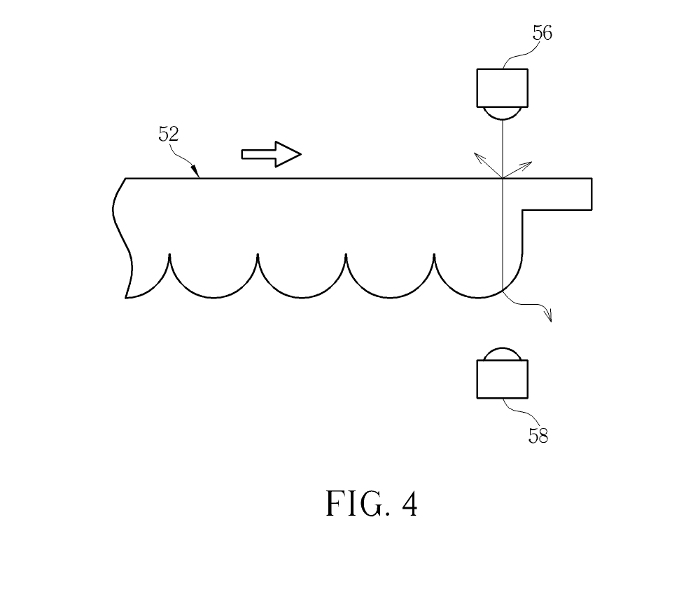

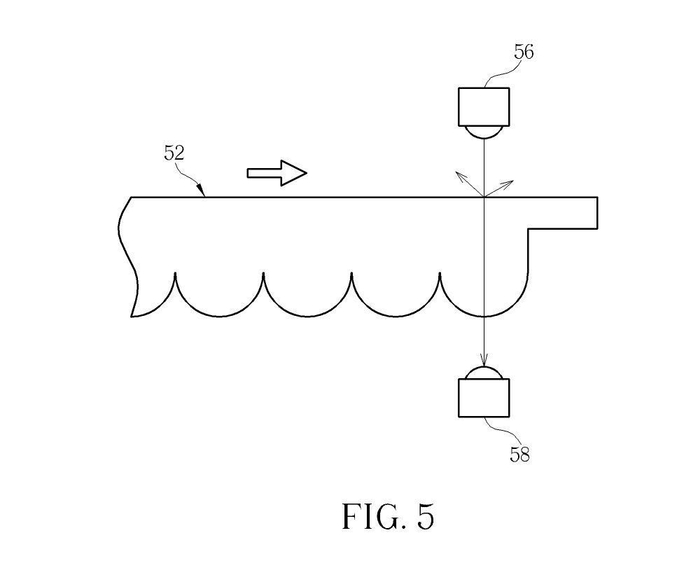

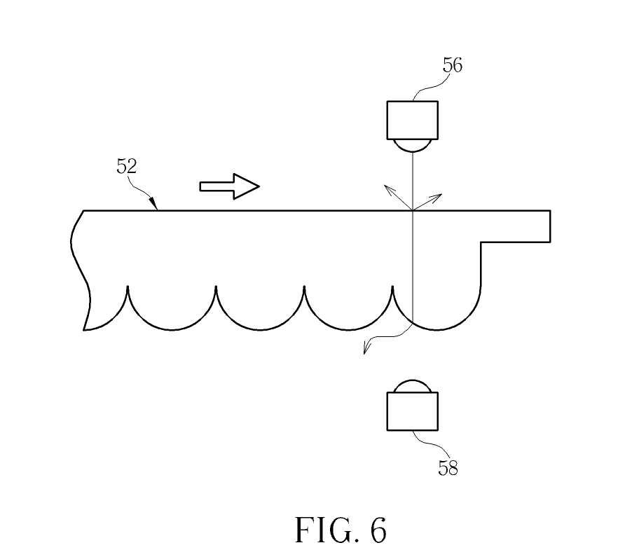

Detail description of above procedure is described herein. As the light sensor 58 is an optical interrupter sensor, the light source 56 can be disposed in front of the planar side 521 of the transparent grating structure 52, and the light sensor 58 can be disposed in front of the cylindrical side 523 of the transparent grating structure 52. Please refer to FIG. 3 to FIG. 6. FIG. 3 to FIG. 6 are respectively diagrams of the light source 56, the light sensor 58 and the transparent grating structure 52 in different positions according to the preferred embodiment of the present invention. The actuating unit 54 can drive the transparent grating structure 52 to move in the X direction, so that every grating of the transparent grating structure 52 can pass between the light source 56 and the light sensor 58 one by one. The light source 56 can emit the light in the Y direction. Because the transparent grating structure 52 has a property of transparency, the light emitted from the light source 56 can penetrate the transparent grating structure 52 and can be sensed by the light sensor 58. It is noticed that when an edge of the transparent grating structure 52 is moved to a position between the light source 56 and the light sensor 58, the light emitted from the light source 56 will scatter in other directions, just because the edge of the transparent grating structure 52 is uneven and the light travels through the interface between different mediums. As a result, the light sensor 58 senses weak light so as to generate a minimum optical intensity signal. As shown in FIG. 4 and FIG. 6, when a convex (but not the top) of the transparent grating structure 52 is moved to the position between the light source 56 and the light sensor 58, the light emitted from the light source 56 will refract due to the convex of the transparent grating structure 52 so that the light sensor 58 also senses weak light and cannot generate a maximum optical intensity signal. As shown in FIG. 5, only when the top of the transparent grating structure 52 moves to the position between the light source 56 and the light sensor 58, the light sensor 58 can sense strongest light, just because the light emitted from the light source 56 directly penetrates the top of the transparent grating structure 52 almost without refraction, so as to generate the maximum optical intensity signal.

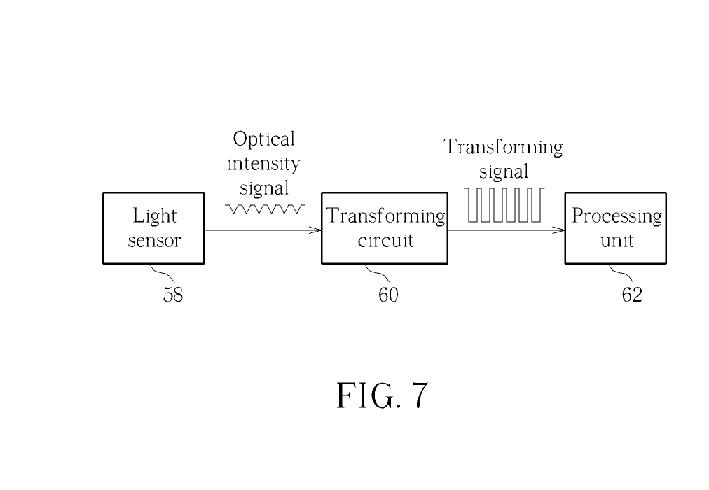

Please refer to FIG. 7. FIG. 7 is a diagram of transforming the optical intensity signal into the transforming signal according to the preferred embodiment of the present invention. Because the level changes of the optical intensity signal generated by the light sensor 58 are weak, in order to increase accuracy of determination, the transforming circuit 60 can be utilized for amplifying the level changes of the optical intensity signal so as to generate the transforming signal. And then the processing unit 62 can determine the position of every grating of the transparent grating structure 52 according to the transforming signal transmitted from the transforming circuit 60. For example, every grating of the transparent grating structure 52 respectively corresponds to a level change of the optical intensity signal, which means that the top of the transparent grating structure 52 corresponds to the maximum optical intensity signal and the other portions of the transparent grating structure 52 correspond to weaker optical intensity signals. Positions and amounts of the gratings of the transparent grating structure 52 can be determined according to a waveform of level changes of the transforming signal, for providing a basis of locating and printing the stereoscopic image in following procedure.

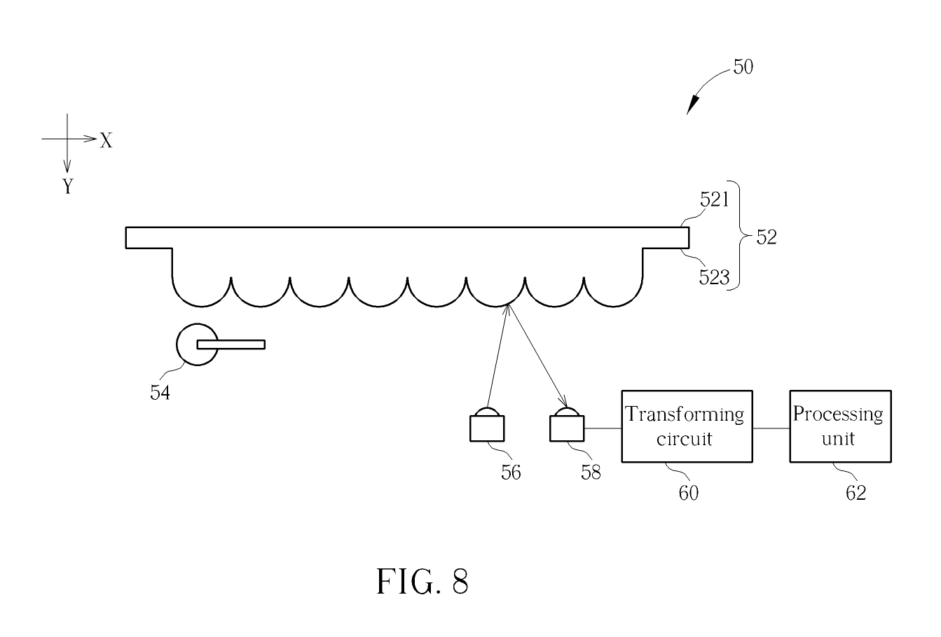

Moreover, the light sensor 58 of the present invention can selectively be an optical reflective sensor. Please refer to FIG. 8. FIG. 8 is a diagram of the detecting device 50 according to another embodiment of the present invention. The difference between this embodiment and previous one is that the light source 56 and the light sensor 58 are both disposed in front of the cylindrical side 523 of the transparent grating structure 52 in this embodiment. Similar to the previous embodiment, when the convex (not the top) of the transparent grating structure 52 is moved to a position corresponding to the light source 56, the light sensor 58 senses stronger reflective light because the convex of the transparent grating structure 52 reflects the light emitted from the light source 56, and therefore the light sensor 58 generates the stronger optical intensity signal. But when the top of the transparent grating structure 52 is moved to the position corresponding to the light source 56, the light sensor 58 senses weaker light because most of the light emitted from the light source 56 penetrates the top of the transparent grating structure 52 and there is almost no reflective light, so that the light sensor 58 generates the minimum optical intensity signal. As for the operational principles of the transforming circuit 60 and the processing unit 62 are similar to the previous embodiment and are omitted herein. Furthermore, the positions and amounts of the light source 56 and the light sensor 58 are not limited to above embodiments. For example, the present invention can include multiple sets of light sources and light sensors, such as two sets, and those components can be disposed at two sides of the transparent grating structure or two ends of a travelling path of the transparent grating structure, so as to locate the transparent grating structure more accurately and to correct errors due to the inappropriate cut or skew of the transparent grating structure, and it depends on practical design demand.

In contrast to the prior art, the detecting device and the detecting method of the present invention can utilize the light sensor and the transforming circuit to detect and locate the transparent grating structure directly. Therefore, there is no need to print the stereoscopic image on an opaque substrate, such as photographic paper or cards and so on, and then to stick the transparent grating plate on the substrate. That is, the step of configuring the substrate and sticking the transparent grating plate on the substrate can be omitted. For example, the stereoscopic image can be directly printed on the planar side of the transparent grating plate, so as to reduce manufacturing difficulty and cost greatly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detecting device comprising:
an actuating unit for driving a transparent grating structure;
a light source for emitting light to the transparent grating structure driven by the actuating unit;
a light sensor for sensing the light emitted from the light source as the transparent grating structure is moved to different positions relative to the light source so as to generate a corresponding optical intensity signal;
a transforming circuit coupled to the light sensor for transforming the optical intensity signal into a transforming signal, and
a processing unit coupled to the transforming circuit for determining a position of the transparent grating structure according to the transforming signal transmitted from the transforming circuit.

2. The detecting device of claim 1, wherein the light source is a light emitting diode, and the light sensor is an optical interrupter sensor for sensing the light emitted from the light source and passing through the transparent grating structure so as to generate the corresponding optical intensity signal.

3. The detecting device of claim 2, wherein the light source is disposed at a planar side of the transparent grating structure, and the light sensor is disposed at a cylindrical side of the transparent grating structure.

4. The detecting device of claim 3, wherein the light sensor generates the maximum optical intensity signal when a top of the transparent grating structure is moved to a position between the light source and the light sensor.

5. The detecting device of claim 3, wherein the light sensor generates the minimum optical intensity signal when an edge of the transparent grating structure is moved to a position between the light source and the light sensor.

6. The detecting device of claim 1, wherein the light source is a light emitting diode, and the light sensor is an optical reflective sensor for sensing the light emitted from the light source and reflected by the transparent grating structure so as to generate the corresponding optical intensity signal.

7. The detecting device of claim 6, wherein the light source and the light sensor are disposed at a cylindrical side of the transparent grating structure.

8. The detecting device of claim 6, wherein the light sensor generates the minimum optical intensity signal when a top of the transparent grating structure is moved to a position relative to the light source.

9. The detecting device of claim 1, wherein the transforming circuit is for amplifying level changes of the optical intensity signal so as to generate the transforming signal.

10. The detecting device of claim 1, wherein a direction of movement of the transparent grating structure driven by the actuating unit is substantially vertical to a direction of the light emitted from the light source.

11. A method for detecting a transparent grating structure, comprising:
driving the transparent grating structure;
a light source emitting light to the transparent grating structure;
a light sensor sensing the light emitted from the light source as the transparent grating structure is moved to different positions relative to the light source so as to generate a corresponding optical intensity signal;
transforming the optical intensity signal generated by the light sensor into a transforming signal, and
determining a position of the transparent grating structure according to the transforming signal.

12. The method of claim 11, further comprising disposing the light source at a planar side of the transparent grating structure, and disposing the light sensor at a cylindrical side of the transparent grating structure, wherein the light sensor senses the light emitted from the light source and passing through the transparent grating structure.

13. The method of claim 12, wherein the light sensor generates the maximum optical intensity signal when a top of the transparent grating structure is moved to a position between the light source and the light sensor.

14. The method of claim 12, wherein the light sensor generates the minimum optical intensity signal when an edge of the transparent grating structure is moved to a position between the light source and the light sensor.

15. The method of claim 11, further comprising disposing the light source and the light sensor at a cylindrical side of the transparent grating structure, wherein the light sensor senses the light emitted from the light source and reflected by the transparent grating structure.

16. The method of claim 15, wherein the light sensor generates the minimum optical intensity signal when a top of the transparent grating structure is moved to a position relative to the light source.

17. The method of claim 11, wherein transforming the optical intensity signal generated by the light sensor into a transforming signal comprises amplifying level changes of the optical intensity signal so as to generate the transforming signal.

18. The method of claim 11, wherein a direction of driving the transparent grating structure is substantially vertical to a direction of the light emitted from the light source.
